(19) United States
(12) Patent Application Publication
(10) Pub. No.: US 2008/0168894 A1
(43) Pub. Date: Jul. 17, 2008

(54) Multimedia keyboard structure

(76) Inventor: Tsung-Cheng Kuo, Taoyuan Hsien (TW)

Correspondence Address: TROXELL LAW OFFICE PLLC, Suite 1404, 5205 Leesburg Pike, Falls Church, VA, 22041, US

(21) Appl. No.: 11/652,671

(22) Filed: Jan. 12, 2007

(51) Int. Cl. G10H 1/32

(52) U.S. Cl. 84/744

(57) ABSTRACT

A multimedia keyboard structure comprises a keyboard main body, a control circuit, an audio input device, and several audio output devices. The keyboard main body comprises a shell, a bracket engaged with the shell correspondingly, and several independent sound chambers defined by the shell and the bracket jointly. The control circuit is held in the keyboard main body. The control circuit comprises several high-pass filters, several low-pass filters, and several power amplifiers. The audio input device is held in the keyboard main body, and electrically connected with the control circuit for receiving the sounds. The audio output devices are held in the sound chambers, and electrically connected with the control circuit. Because the control circuit drives the audio output devices and the sound chambers provides the resonance effect, the present invention can provide the advantages of improving space efficiency, integrating lines, and increasing tone quality and efficiency of speakers.

### FIELD OF THE INVENTION

The present invention relates to a multimedia keyboard structure, and more particularly to a multimedia keyboard structure that drives the audio output devices via the control circuit and provides the resonance effect via the sound chambers so as to provide the advantages of improving space efficiency, integrating lines, and increasing tone quality and efficiency of speakers.

### BACKGROUND OF THE INVENTION

The existing keyboards have several kinds of functions integrated thereon. For example, the speakers for audio output are mounted inside the keyboard so as to provide the keyboard with the typewriting function and the audio output function. The space occupied by the speakers can be thus omitted. In addition, the power lines can be thus reduced. Accordingly, these keyboards are easy to use and make the space to be allocated freely.

But, the existing commercial keyboards having the speakers mounted thereon are limited by the power of the output interface (PS/2 and USB), causing the output wattage of the speakers unable to be raised. Moreover, these speakers cannot output the noise-free, pure sounds. Instead of tolerating the low wattage and poor tone quality of the keyboard speakers, the consumers prefer to install another set of speakers and provide these additional speakers with additional power source. Accordingly, the built-in speakers of the keyboard can not bring the predetermined functions into fully play, causing the built-in speakers to act as decorations.

As a result, the problem needs to be solved by the present invention is to improve the above-mentioned keyboard's audio output and provide the keyboard with multiple functions.

### SUMMARY OF THE INVENTION

In view of the foregoing problem, the present invention discloses a multimedia keyboard structure for industrial use.

In order to achieve the foregoing object and other objects, a multimedia keyboard structure is supplied with the electric power via an output interface of computer, and the multimedia keyboard structure is comprised of a keyboard main body, a control circuit, an audio input device, and several audio output devices.

The keyboard main body comprises a shell, a bracket engaged with the shell correspondingly, several sound chambers defined by the shell and the bracket jointly, and at least an input terminal.

The control circuit is held in the keyboard main body, and coupled with the input terminal. The control circuit comprises several high-pass filters, several low-pass filters, and several power amplifiers. The high-pass filters and said low-pass filters are electrically connected with a respective one of the power amplifiers.

The audio input device is held in the keyboard main body, and electrically connected with the control circuit for receiving the sounds.

The audio output devices are held in the sound chambers, and electrically connected with the control circuit. The audio output devices comprise at least a high-pitched speaker and at least a low-pitched speaker. The high-pitched speaker and the low-pitched speaker are electrically connected with the output terminals of the power amplifiers.

By using the aforesaid technology, the present invention provides the advantages of improving space efficiency, integrating lines, and increasing tone quality and efficiency of speakers.

### BRIEF DESCRIPTION OF THE DRAWINGS

These and other features, aspects and advantages of the present invention will become better understood with regard to the following description, appended claims, and accompanying drawings, wherein:

FIG. 1 is an elevational view showing a preferred embodiment of the present invention.

FIG. 2 is an elevational, decomposed view showing the preferred embodiment of the present invention.

FIG. 3 is a cross-sectional view taken along line A-A in FIG. 1.

FIG. 4 is a block diagram showing the preferred embodiment of the present invention.

### DETAILED DESCRIPTION OF THE PREFERRED EMBODIMENT

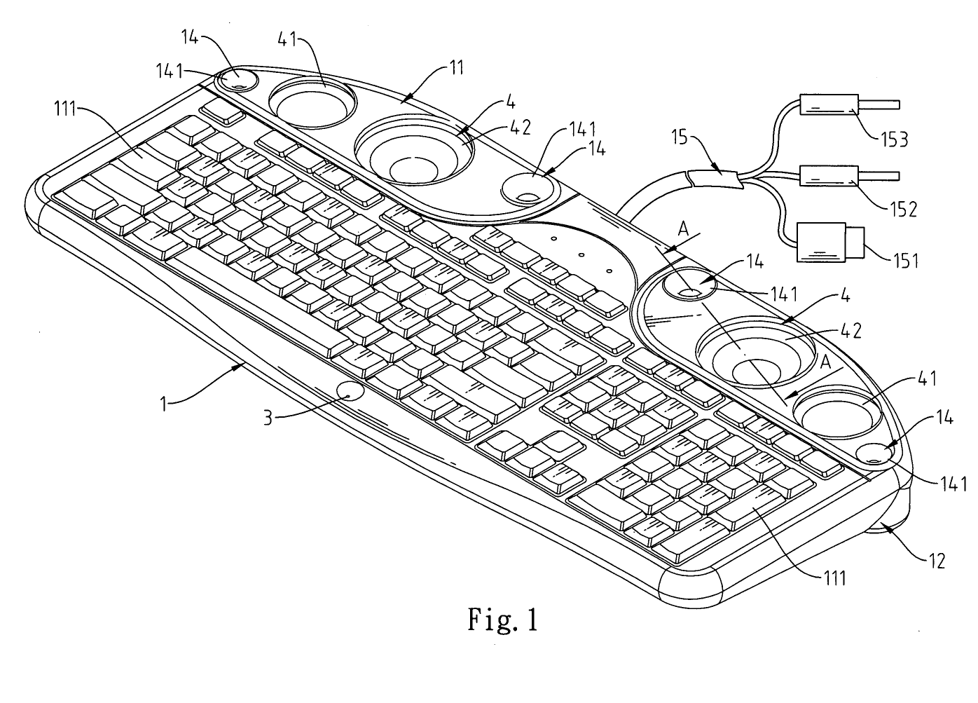

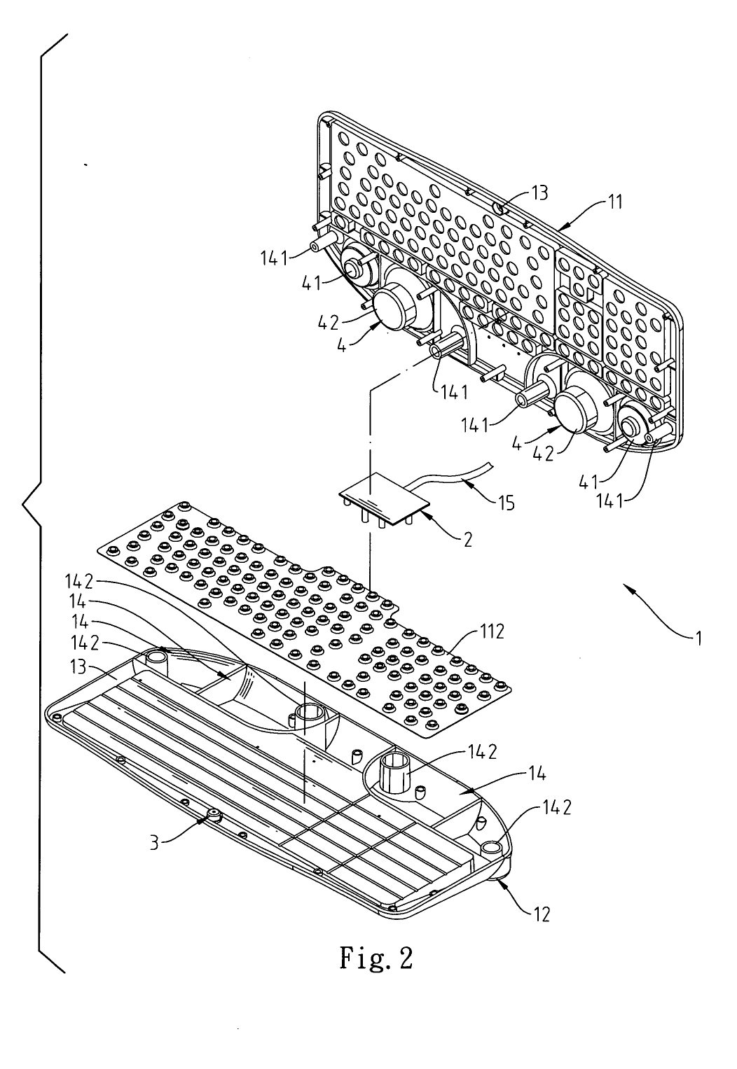

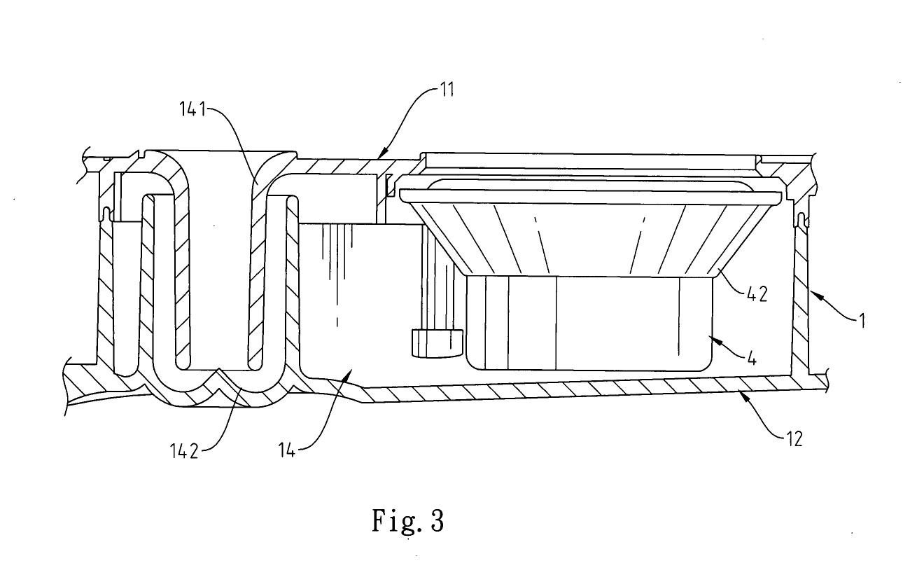

Referring to FIG. 1 through FIG. 4, a multimedia keyboard structure of the present invention is supplied with the electric power via an output interface of computer 92. The multimedia keyboard structure comprises a keyboard main body 1, a control circuit 2, an audio input device 3, and several audio output devices 4.

The keyboard main body 1 comprises a shell 11, a bracket 12 engaged with the shell 11 correspondingly, several independent holding chambers 13 and sound chambers 14 defined by the shell 11 and the bracket 12 jointly, and at least an input terminal 15. Several buttons 111 are mounted on a lateral surface of the shell 11. A shock-absorption plastic plate 112 is disposed on the inner lateral surfaces of the buttons 111 to reduce the shock. The sound chambers 14 have several reflection ducts 141 extending inward from the shell 11 and several sound cups 142 extending inward from the bracket 12. The sound cups 142 are located to cover the outsides of the reflection ducts 141. The sound cups 142 and the reflection ducts 141 are spaced by a certain distance. The input terminal 15 has an interface connector 151, an audio input connector 152, and an audio output connector 153.

The control circuit 2 is held in the independent holding chambers 13 of the keyboard main body 1, and coupled with the input terminal 15. The control circuit 2 comprises several high-pass filters 21, several low-pass filters 22, several power amplifiers 23, and a smoothing circuit 24. The input terminal 15 is connected with the high-pass filters 21, the low-pass filters 22, and the smoothing circuit 24 so as to output the electric power to the smoothing circuit 24. The smoothing circuit 24 is electrically connected with the high-pass filters 21, the low-pass filters 22, and the power amplifiers 23 so as to supply them with the electric power. The high-pass filters 21 and the low-pass filters 22 are electrically connected with respective power amplifiers 23.

The audio input device 3 is held in the independent holding chambers 13 of the keyboard main body 1, and electrically connected with the control circuit 2 for receiving the sounds. The audio input device 3 is such as a microphone.

The audio output devices 4 are held in the sound chambers 14 of the keyboard main body 1, and electrically connected with the control circuit 2. The audio output devices 4 comprise at least a high-pitched speaker 41 and at least a low-pitched speaker 42. The high-pitched speaker 41 and the low-pitched speaker 42 are electrically connected with the output terminals of the power amplifiers 23.

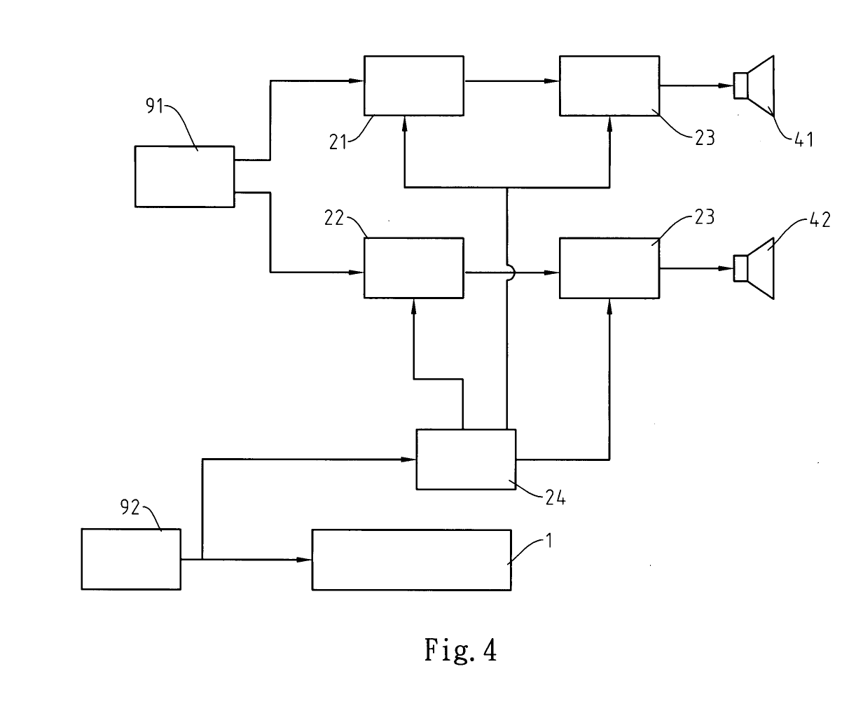

The usage status of the aforesaid components is shown in FIG. 4. The multimedia keyboard structure of the present invention is connected with the output interface of computer 92 via the interface connector 151 of the input terminal 15. The interface connector 151 is, for example, a PS/2 or USB connector. In addition, the audio input connector 152 and the audio output connector 153 of the input terminal 15 are electrically connected with an audio input/output interface of computer 91, which is designed for receiving the sounds received by the audio input device 3. The audio input/output interface of computer 91 is designed for transmitting the audio signals to the high-pass filters 21 and the low-pass filters 22 so as to form the high-frequency and low-frequency sound waves after filtration by the high-pass filters 21 and the low-pass filters 22 of the control circuit 2 for increasing the dynamic range of sound waves. After amplifying the power of the high-frequency and low-frequency sound waves by the respective power amplifier 23, the high-frequency and low-frequency sound waves are then broadcasted via the high-pitched speaker 41 and the low-pitched speaker 42. The sound chambers 14 provide the resonance effect to better the effect of audio output.

In addition, it is worthy to notice that the control circuit 2 can process the signals of the left and right audio channels simultaneously. Moreover, the sound is outputted via the audio input device 3. Of course the multimedia keyboard structure of the present invention may have multiple audio channels, which are properly configured to achieve the identical purposes and effects as described above.

What the invention claimed is:

1. A multimedia keyboard structure supplied with the electric power via an output interface of computer, comprising:
a keyboard main body comprising a shell, a bracket engaged with said shell correspondingly, a plurality of sound chambers defined by said shell and said bracket jointly, and at least an input terminal;
a control circuit held in said keyboard main body and coupled with said input terminal, said control circuit comprising a plurality of high-pass filters, a plurality of low-pass filters, and a plurality of power amplifiers, said high-pass filters and said low-pass filters being electrically connected with a respective one of said power amplifiers;
an audio input device held in said keyboard main body and electrically connected with said control circuit for sound reception; and
a plurality of audio output devices held in said sound chambers, and electrically connected with said control circuit, said audio output devices comprising at least a high-pitched speaker and at least a low-pitched speaker, said high-pitched speaker and said low-pitched speaker being electrically connected with a plurality of output terminals of said power amplifiers.

2. A multimedia keyboard structure of claim 1, further comprising a shock-absorption plastic plate disposed on an inner lateral surface of said shell to reduce the shock.

3. A multimedia keyboard structure of claim 1, wherein said audio input device is a microphone.

4. A multimedia keyboard structure of claim 1, wherein said input terminal has an interface connector, an audio input connector, and an audio output connector.

5. A multimedia keyboard structure of claim 4, wherein said interface connector is a PS/2 connector.

6. A multimedia keyboard structure of claim 4, wherein said interface connector is a USB connector.

7. A multimedia keyboard structure of claim 4, wherein said interface connector is a PS/2 and USB connector.
